(19) United States
(12) Patent Application Publication
(10) Pub. No.: US 2002/0036105 A1
(43) Pub. Date: Mar. 28, 2002

(54) Vehicle drive system

(76) Inventors: Thomas Birmanns, Balingen (DE); Johannes Dorndorfer, Lauchheim (DE)

Correspondence Address: RATNER & PRESTIA, P O BOX 980, VALLEY FORGE, PA, 19482

(21) Appl. No.: 09/956,686

(22) Filed: Sep. 20, 2001

(30) Foreign Application Priority Data
Sep. 22, 2000 (DE) DE 100 46 963.9

(51) Int. Cl. B60K 1/00

(52) U.S. Cl. 180/65.1

(57) ABSTRACT

A vehicle, particularly a wheelchair, comprises a wheelchair frame, an electronic control unit and at least two driving wheels, wherein at least the first driving wheel includes a device for manually applying a drive force and at least the second driving wheel is adapted to be driven via a drive unit having an electric motor. The electronic control unit is adapted to detect the distance covered by the first driving wheel due to rotation of said first driving wheel and to drive the drive unit having an electric motor of the second driving wheel depending on the distance covered by the first driving wheel for turning the second driving wheel.

### BACKGROUND OF THE INVENTION

The invention relates to a vehicle, particularly a wheelchair, having a vehicle frame, an electronic control unit and at least two driving wheels and being adapted for persons suffering from hemiplegia.

Persons suffering from hemiplegia are paralyzed on one side of their body. Usually, one side of the body of the person suffering from hemiplegia is fully functioning. Depending on the degree of being paralyzed on his or her other side, a person suffering from hemiplegia needs to use a wheelchair.

German patent application DE 198 48 530 discloses a wheelchair having a drive assistance device. This known wheelchair has two running wheels adapted to be driven, each of said running wheels adapted to be driven having a separate drive unit comprising an electric motor, an accumulator assembly and a control unit. Each of said two running wheels adapted to be driven comprises further a hand rim which is mounted to said running wheel such that it can be shifted with respect to said running wheel to a certain degree in the circumferential direction thereof. A manual driving force can be applied manually to said hand rim. The displacement of the hand rim with respect to the running wheel can be detected by a sensor. This sensor provides corresponding signals to the control unit which drives the electric motor to provide a torque which assists the manually induced driving force. A manually induced braking force can be supported in the same way by said electric motor.

Such drive assistance device provides that there is no excessive strain to the muscles and joints of the driver of the wheelchair in case of climbing or descending a hill. At the same time, the therapeutic value of manually driving the wheelchair by the driver of the wheelchair is maintained. The degree of drive assistance of this drive assistance device can be adjusted depending on the physical capabilities of the driver of the wheelchair.

### SUMMARY OF THE INVENTION

The technical problem underlying the invention is to provide a vehicle, particularly a wheelchair, to which a manual driving force of the wheelchair driver can be applied on only one side wherein this manual driving force is supported by a drive unit having an electric motor so that the vehicle or wheelchair, respectively, is adapted to be used by a person suffering from hemiplegia.

The object underlying this technical problem is solved by a vehicle or wheelchair, respectively, as defined in the claims.

According to the present invention, there is provided a vehicle, particularly a wheelchair having a vehicle frame, an electronic control unit and at least two driving wheels. At least one driving wheel includes a device for receiving a manually applied driving force. A second driving wheel is adapted to be driven by a driving unit having an electric motor. The driving unit having an electric motor is adapted to detect the distance covered by said first driving wheel and to drive said driving unit having an electric motor for rotating said second driving wheel in dependence of the distance covered by said first driving wheel. In other words, the distance covered by the wheel rotated by manual force is detected and the second wheel which is not rotated by direct application of manual force is driven by a driving unit having an electric motor in dependence on the distance covered by said first manually driven driving wheel.

The most important motion in using a wheelchair is driving straight ahead. However, driving straight ahead is difficult to accomplish if operation is effected only on one side since a driving force induced only on one side causes turning of the wheelchair. The principle according to the present invention is based on that the distance which a first wheel drivable by manual force covers is measured and a drive unit having an electric motor is controlled such that a second driving wheel covers a distance which corresponds to that of the first driving wheel. In case of driving straight ahead this means that the drive unit having an electric motor is controlled such that the second driving wheel covers the same distance as the first driving wheel. This results in driving of the vehicle straight ahead.

In case the vehicle is to take a corner, the drive unit having an electric motor is controlled such that the second driving wheel covers a distance which is different from the distance covered by the first driving wheel, however has a predetermined ratio to the distance covered by the first driving wheel. This results in the vehicle taking a predetermined corner. Furthermore, it is possible to drive the drive unit having an electric motor such that the driving wheel which is not rotated manually covers the same distance as the driving wheel driven manually, however in an opposite direction, so that the wheelchair is turned on the spot.

A steering unit can be provided at the wheelchair to enable the driver of the wheelchair to steer the wheelchair. Depending on how the steering unit is operated by the driver of the wheelchair the wheelchair may go straight ahead, take a predetermined corner having various radii or may turn on the spot.

According to a first embodiment of the invention a wheelchair comprises two driving wheels and two wheels which are not driven and which can rotate freely. A first driving wheel includes a hand rim for manually applying a driving force and only the second driving wheel is adapted to be driven by a drive unit having an electric motor. Accordingly, driving of the first driving wheel exclusively is effected by muscle power of the driver of the wheelchair and driving of the second driving wheel is supported via said electric motor wherein control of said drive unit having said electric motor is effected in dependence of operation of a steering unit and depending on the distance covered by the manually driven driving wheel.

According to another embodiment of the invention the first driving wheel includes, in addition to a device for manually applying a driving force which is preferably a hand rim, a separate drive unit having an electric motor, said drive unit being adapted to provide support to said manually applied driving force via an electric motor, as well as a sensor unit which is adapted to detect the driving force manually applied to said first driving wheel wherein said electronic control unit is adapted to control the drive unit having an electric motor of the first driving wheel in response to a driving force manually applied to said first driving wheel in order to provide a torque for supporting said manually applied driving force by said electric motor.

In this embodiment of the invention the manually drivable wheel may have a drive assistance device as for instance disclosed in German patent DE 198 48 530. Accordingly, the driver of a wheelchair only provides a portion of the torque necessary to propel the first driving wheel by hand while an additional portion of the driving force being variable depending on a support level is provided by the drive unit having an electric motor. Driving of the second driving wheel which is not driven manually again is effected depending on the distance covered by the first driving wheel.

Preferably, each driving wheel has a separate drive unit having an electric motor wherein each drive unit has an electric motor, an accumulator assembly and an electronic control unit. The electronic drive unit of the first driving wheel which can be propelled manually is particularly adapted to provide support of the manually applied torque via the electric motor by controlling the electric motor of the first driving wheel correspondingly. The electronic control unit of the second driving wheel which is not propelled by hand controls the electric motor of the second driving wheel depending on signals corresponding to the distance covered by the first driving wheel. The necessary transmission of signals from the first driving wheel to the second driving wheel can be provided via contact rings and contact pins and cables installed at the vehicle frame or wireless, i.e. for instance via optical, capacitive or inductive transmission, via radio transmission or via ultra sound.

In case of non-contact transmission of signals each driving wheel preferably has a driving wheel sending unit for non-contact or wireless transmission of signals and a driving wheel receiving unit for non-contact or wireless receipt of external signals. External signals in this context are signals which are transmitted from a signal transmission unit outside the respective driving wheel, i.e. a signal transmission unit which is not part of the respective driving wheel.

Furthermore, a vehicle frame sending unit can be provided at the vehicle frame for non-contact transmission of signals to the driving wheel receiving unit and a vehicle frame receiving unit can be provided for non-contact receipt of signals. The vehicle frame sending unit may serve to transmit ON or OFF signals to the driving wheel receiving unit of the driving wheels. This may serve to provide easy and simultaneously switching ON or OFF of the driving wheels which is particularly relevant for persons suffering from hemiplegia. Moreover, selection of a drive level concerning the first driving wheel can be effected by means of the vehicle frame sending unit. For instance, a support level may be set, i.e. the ratio between the manual driving force and the supporting driving force provided by the electric motor or certain after-running conditions, i.e. the driving characteristics of the electric motor after termination of application of manual driving force can be selected.

The vehicle frame sending unit can be arranged in or at an operation unit. It can be integrated in this operation unit or can be designed as a component separate from the operation unit. If the operation unit is provided as a component which can be detached from the vehicle frame, this operation unit can have the function of a key so that switching ON of the driving units having electric motors of the driving wheels is not possible without this operation unit.

If designed appropriately, it is furthermore possible to use this operation unit as a remote control for the vehicle. This function can be particularly useful for wheelchairs for persons who cannot walk properly or who are unable to walk and for persons having a reduced capacity for steering the vehicle. For instance, it is possible that a handicapped person who cannot walk properly drives the wheelchair from a remote position to his or her bed while he or she is in the bed via such remote control or, while sitting on the driver's seat of a motor car, drive a wheelchair discharged from a rear portion of this motor car via an appropriate device to a position approximate to the opened driver's door of the motor car so that he or she can change from the driver seat into the wheelchair without outside help.

The control unit of those embodiments of the invention as described above wherein each driving wheel has its own driving unit having an electric motor is preferably designed to provide various safety and comfort functions. It is for instance possible to switch OFF one driving wheel automatically if the other driving wheel is out of order. The term “out of order” comprises inter alia a switched OFF state, a fault of the driving unit having an electric motor or an insufficient charging condition of the accumulator assembly of the driving unit. If for reasons of this kind the driving unit of one driving wheel is out of order, the driving wheel sending unit of this driving wheel sends corresponding signals or the corresponding state is indicated by non-appearance of control signals. These signals can be received by a central control unit or by a control unit of the other driving wheel whereupon the respective control unit causes the other driving wheel to be switched OFF. Those vehicles having a separate accumulator assembly for each driving wheel further provide the possibility that both driving wheels are switched OFF simultaneously if the driving wheel sending unit of one wheel transmits a signal which contains the information that the charging condition of the accumulator assembly of this wheel has reached a predetermined lower threshold value.

If a separate control unit is provided for each driving wheel, these control units can be designed such that both driving wheels can be simultaneously switched ON or OFF by means of a switch which is disposed at one driving wheel. In this embodiment it is therefore not necessary to provide a central operation unit, for instance an operation unit arranged at the vehicle frame, because the corresponding exchange of signals can be effected directly between both driving wheels.

In a further advantageous embodiment of the invention a vehicle frame receiving unit for contactless receipt of signals, particularly from a driving wheel sending unit, is provided at the vehicle frame. This enables not only a feedback in case of control operations or drive operations of different kinds via a central control unit but furthermore in connection with a display device display of operation parameters of various kinds, for instance stand-by status of the vehicle or single components thereof, capacity of the accumulators or the accumulator, a set driving level, possible interruptions and faults as well as further operational data, particularly regarding time, speed and distance including a trip counter. Furthermore, the energy applied by the driver of the wheelchair can be added up and displayed which is particularly useful for therapeutic reasons. The display can be effected by means of optical signals, for instance light-emitting diodes, luminous figures and liquid crystal displays or analog display instruments, by means of acoustic signals, for instance via beepers or warning sounds, by means of vibration of components designed appropriately or by heating of respective components. The kind of display or giving notice depends particularly on the parameter to be displayed and the level and kind of handicap of the person for which the wheelchair is designed.

### BRIEF DESCRIPTION OF THE DRAWINGS

The invention is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following Figures:

FIG. 1 is a schematic depiction of the functional allocation and reference between two driving wheels of an embodiment of a wheelchair;

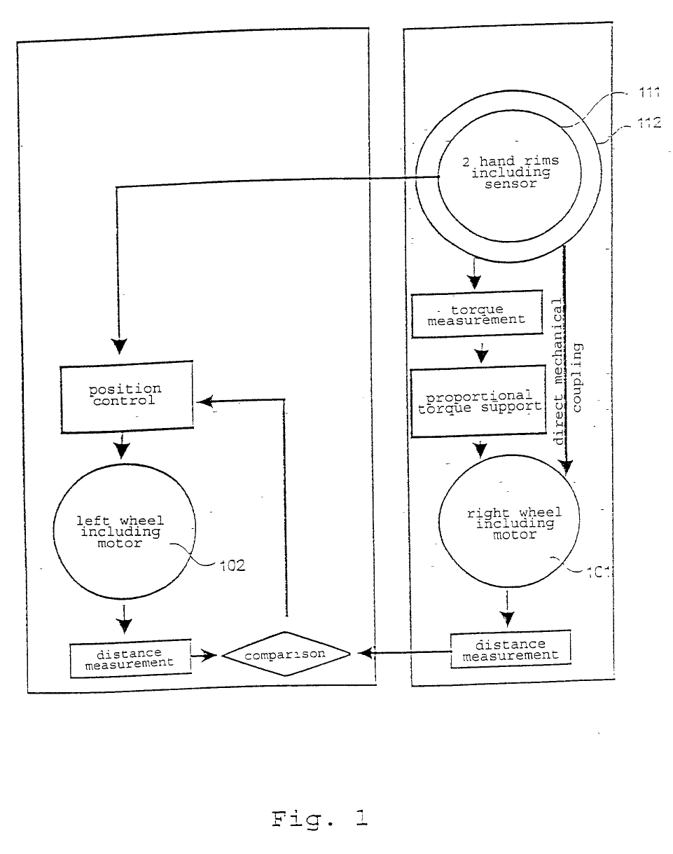

FIG. 2 is a schematic depiction of the hardware components of the control unit of a driving wheel adapted to be manually driven;

FIG. 3 is a schematic depiction of the flow of communication of an embodiment of a wheelchair according to FIG. 1;

FIG. 4 is a flow chart for showing the start routine between master and slaves;

FIG. 5 is a flow chart for showing the communication during operation of the wheelchair; and

FIG. 6 is a flow chart for showing the communication in the learning phase for recognizing and storing network members.

### DESCRIPTION OF THE PREFERRED EMBODIMENTS

The embodiments explained in the following are based on a wheelchair having two driving wheels. Each driving wheel includes a separate driving unit having an electric motor, an accumulator assembly and a control unit. The driving wheels are detachable mounted to a wheelchair frame. The mounting is effected via a plug-in axle and a torque support. A first driving wheel 101 has two hand rims 111, 112. A person sitting in the wheelchair can manually cause rotation of the driving wheel 101 via these hand rims 111, 112. Sensors 417 are disposed at the hand rims 111, 112 which sensors measure the propelling force manually applied and transmit corresponding signals to a control unit 401. The functions of both hand rims 111, 112 are further explained below. Depending on a preselected drive level the control unit 401 drives the electric motor 404 of the driving wheel 101 to support the manually induced propelling force. If a brake force is manually induced via one of the hand rims 111, 112 while the wheelchair is driving, this brake operation is supported by the electric motor 404 correspondingly.

The second driving wheel 102 does not have any hand rims. The electric motor and the accumulator assembly of the second driving wheel 102 can be identical with the electric motor 404 and the accumulator assembly 402 of the first driving wheel 101. The control unit of the second driving wheel 102 corresponds substantially to the control unit 401 of the first driving wheel 101. However, while the control unit 401 of the first driving wheel 101 is adapted to drive the electric motor 404 in dependence of a torque, i.e. in response to a torque manually applied to one or both of said hand rims 111, 112, the control unit of the second driving wheel 102 is adapted to drive the electric motor of the second driving wheel 102 in response to a distance signal of the first driving wheel 101. The measuring of the distance is effected at the first driving wheel 101 by means of a position sensor 405 and at the second driving wheel 102 by a corresponding position sensor. The control unit of the second driving wheel 102 controls the electric motor of the second driving wheel 102, provided no steering unit is operated, such that the second driving wheel 102 covers the same distance as the first driving wheel 101. This ensures driving straight ahead of the wheelchair even if the wheelchair is going uphill or traveling along an inclined plane.

If a steering unit is operated, the control unit of the second driving wheel 102 controls the electric motor of the second driving wheel 102 such that the distance covered by the second driving wheel 102 has a certain ratio to the distance covered by the first driving wheel 102 but is different therefrom. The difference of the distances covered by both driving wheels with respect to the sign, i.e. the direction, and/or the amount depends on operation of this steering unit.

If for instance the first, manually drivable driving wheel 101 as the active driving wheel is disposed on the right hand side and the second, distance controlled driving wheel 102 as the passive driving wheel is disposed on the left hand side of the wheelchair, a steering command to the left while driving ahead is put into effect such that the distance covered by the second driving wheel 102 on the left hand side of the wheelchair is smaller that the distance covered by the first driving wheel 101 on the right hand side of the wheelchair. This is based on the principle that the wheel closer to the center of a curve covers a shorter distance while taking a corner than the wheel further apart from the center of the curve. In a corresponding manner the same embodiment effects driving of a right hand turn by providing that the distance covered by the second driving wheel 102 disposed on the left hand side is set to be longer than the distance covered by the first driving wheel 101 disposed on the right hand side.

The steering unit is not shown in the figures. Depending on the kind and extent of the handicap of the driver of the wheelchair different steering units can be used. For instance, a steering unit operated by foot can be provided which effects a left turn upon exerting pressure to the left hand side of an appropriate control element and a right hand turn is effected if pressure is exerted on an appropriate control element to the right hand side, wherein the greater the pressure exerted by the foot is, the smaller the radius of the curve is.

It is furthermore possible to provide the hand rims 111 or 112 or both hand rims 111, 112 not only with a device for measuring a torque in the radial direction for providing a support torque of the electric motor 404 of the first driving wheel 101 but additionally with a sensor unit for detecting a force in the axial direction. If such system is used and pressure is exerted on the hand rim 111 or 112 into the direction of the center of the vehicle, a left hand turn is caused in case the first driving wheel 101 having such hand rims 111, 112 is disposed on the right hand side of the vehicle. If, by contrast, hand rim 111 or 112, respectively, is drawn to the outer side of the vehicle, a right hand turn is effected.

It is further possible to provide an operation level as a steering means. In case a person suffering from hemiplegia is unable to use his or her hand on his or her paralyzed side of the body for manually driving the wheelchair but has sufficient capacity and control to effect steering motions, said operation level can be disposed on the handicapped side. This provides that steering can be effected with the hand on the handicapped side while, at the same time, the healthy hand can be used for driving the wheelchair. If a person suffering from hemiplegia is completely paralyzed on one side of the body, the operation level has to be disposed on the healthy side of the body so that driving and steering has to be effected successively, i.e. step-by-step.

The shown embodiment contains two hand rims 111, 112 which are disposed in a concentric manner. The inner hand rim 112 can serve to cause turning of the wheelchair on the spot. This turning on the spot is effected in that the first driving wheel 101 is rotated in a first direction due to rotation of the inner hand rim 112 is rotated to the same amount in the opposite direction in response to corresponding signals. The same effect of turning on the spot can be caused by providing only one hand rim in connection with an operation lever.

The inner hand rim 112 of two concentric hand rims according to the embodiment as depicted can also be used for initiating driving around a corner. Firstly, the outer hand rim 111 is operated to initiate driving ahead. When the wheelchair is moving, taking a corner in one or the other direction can be effected by turning the inner hand rim 112 in the direction of rotation or by breaking it. The sequence of driving operation thus contains thrusts applied to the outer hand rim 111 and necessary corrections of the driving direction due to operation of the inner hand rim 112.

The embodiments as described above make it possible to retrofit a common mechanical wheelchair without further amendments with a first “active” wheel 101 and a second “passive” wheel 102, wherein the active wheel is disposed on the healthy side and the passive wheel is disposed on the paralyzed side. A person suffering from hemiplegia thus obtains a wheelchair which can be easily operated and has support by means of an electric motor and, at the same time, is easy to steer without having to use the feet and can be controlled even when going fast.

The transmission of signals and data between the driving wheels and, as the case may be, an operation unit (not shown) can be effected in various ways. In case of a wireless connection a safe data connection between various systems within the transmission range, i.e. unambiguous and clear assignment is of crucial importance. The data transmission must be highly resistant against failures even in case that for instance radio channels are permanently covered by other operators. Preferably, multiple radio frequencies are used which change permanently and automatically. In addition to safe data transmission and proper correction of possible failures a lower power consumption in a stand-by modus should be realized. The data transfer rate should be preferably at least 9,600 Baud. If the modus is changed from stand-by to operation and, subsequently, synchronization of the various components is effected, a status ready for operation should be achieved preferably within two seconds. The maximum delay in data transmission should be preferably not more than 40 ms.

If the transmission of data or signals is provided by optical means, it has to be ensured that there is visual communication between the single components. To achieve this, there could be provided for instance three senders and three receivers, respectively, at the parameter of each wheel to provide communication between the wheels.

A capacitive transmission of data or signals between the wheels can be realized by transmission of a carrier frequency via the frame of the vehicle.

Inductive data or signal transmission can be realized by rotating coils at the wheels and stationary coils at the vehicle frame.

If data or signal transmission is effected via radio, particularly the commercially available ranges of frequency of 477 MHz and 868 MHz can be taken into account. It is also possible to use the so-called DECT-standard used in connection with mobile telephones where ten different and permanently automatically changing channels ensure safe connection and ranges of up to 300 m at data transmission rates of 1.15 MB can be realized without problems. It is also possible to use the so-called Bluetooth-standard having a range of between 10 and 100 m, a data transmission rate of 64 kB, 79 channels, a frequency of 2.4 GHz and a power consumption of 0.3 mA in the stand-by modus and at maximum 30 mA during sending operation.

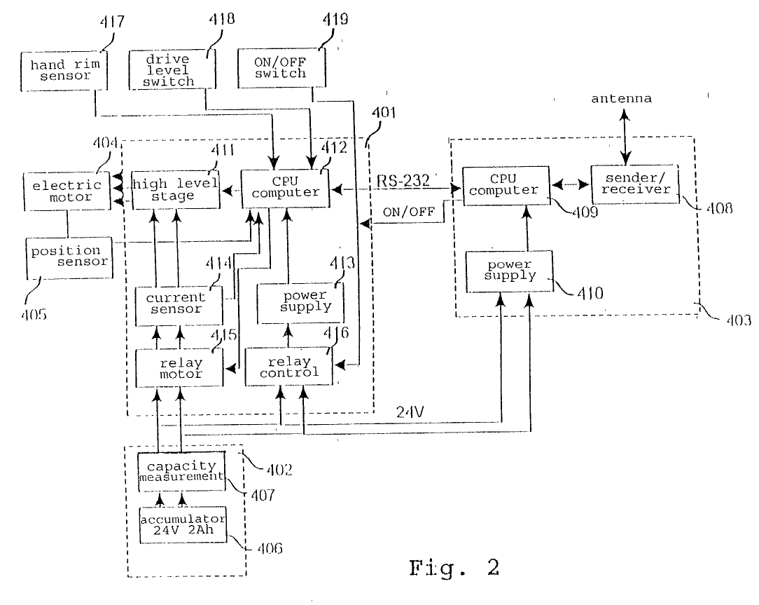

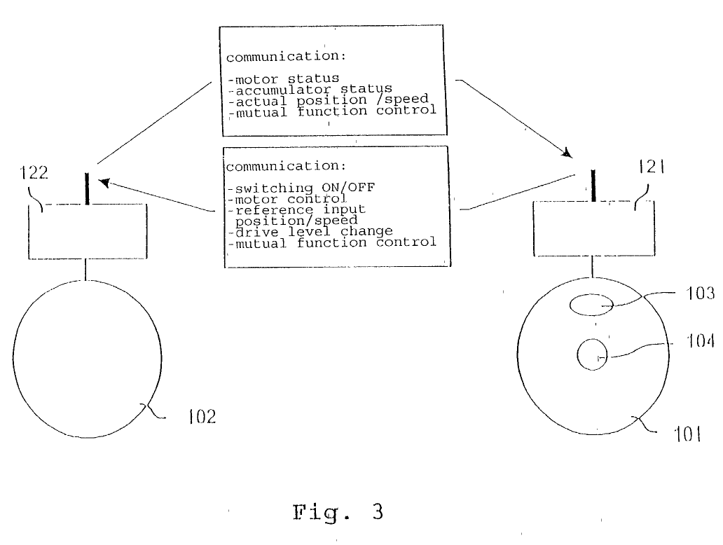

Referring to FIG. 3, an embodiment of a driving unit having an electric motor for the “active” first driving wheel 101 and its linking with a driving wheel receiving unit and a driving wheel sending unit are explained in the following. The flow chart according to FIG. 2 shows a steering unit 401, an accumulator assembly 402, a sending unit 403 and an electric motor 404. The electric motor 404 is designed as a synchronous motor and has a position sensor 405 which is adapted to provide exact measurement of a covered distance. The accumulator assembly 402 includes an accumulator 406 having a charging capacity of 2 Ah and 24V voltage as well as a capacity measuring unit 407. The sending unit 403 includes as a combined component a driving wheel receiving unit and a driving wheel sending unit and comprises a sending and receiving device 408, a computer or calculating means 409 and a power supply 410. The control unit 401 includes a high level stage 411, a computer or calculating means 412, a power supply 413, a current sensor 414, a motor relay 415 and a relay control 416. The computer or calculating means 412 of the control unit 401 is connected with the computer or calculating means 409 of the sending unit 403 via an RS-232 interface. One or a plurality of handrim sensors 417 are adapted to measure a force manually applied to one of the handrims 111, 112 and to provide corresponding signals to the computer or calculating means 412 of the control unit 401. Selection of a drive level is effected via a drive level switch 418 and switching ON or OFF is effected via an ON/OFF switch 419.

The accumulator 406 is an NiCd accumulator having a capacity of 1,900 mAh. The discharge period in a stand-by modus is approximately 30 days. If an NiMh accumulator is used, the charging capacity of the accumulator is reduced due to self-discharging by approximately 1-5 % per day.

The driving unit having an electric motor of the second driving wheel 102, i.e. the passive driving wheel, corresponds basically to the driving wheel having an electric motor as shown in FIG. 2 with the exception that there is no need to provide a handrim sensor and switches for selecting a drive level and for switching ON and OFF.

Referring to FIG. 3, the structure of the network for linking the network components for a wireless signal transmission is explained in the following. Network components in this embodiment are both driving wheels 101, 102 and their control units, respectively. Each network component has its own serial number. In addition, each network component includes information regarding which further network components are present in the system. This check of serial numbers can be effected during production in the production facilities or specifically in a learning process upon delivery of the vehicle to the customer or at any later stage.

Master in the network is always the component which effects switching ON. Accordingly, in the embodiment as shown in FIG. 3 the first driving wheel 101 is master because the ON/OFF switch is provided at this driving wheel. In another embodiment (not shown) where additionally a central operation unit is provided, this central operation unit would be a further network component. In case this central operation unit should have an ON/OFF switch the master in the network would be the component via which the switch ON operation would be effected.

After the master is switched ON, it tries to wake up all slaves, i.e. to raise all slaves from the stand-by modus to an operation modus. A test is conducted whether all network components are present and can be activated. Only after successful activation of all network components the motors are enabled simultaneously. The master determines the timing, sends in prescribed time intervals, for instance every ten milliseconds, its data and receives in return data from the slaves.

The embodiment of a wheel chair as shown in FIG. 3 comprises a first driving wheel 101 which is an active driving wheel and has a drive level switch 103 and an ON/OFF switch 104 as well as a second driving wheel 102 which is designed as passive driving wheel. The active driving wheel 101 is the master in this network. It is disposed on the healthy side of a person suffering from hemiplegia.

Communication from a data transmission unit 122 of the passive wheel 102 to a data transmission unit 121 of the active wheel 101 includes information concerning several operational parameters, particularly regarding the status of the electric motor and the accumulator assembly and additionally information concerning the actual position and speed of the wheel 102 and a mutual function control. The data transmission from the data transmission unit 121 of the active driving wheel 101 to the data transmission unit 122 of the passive driving wheel 102 comprises particularly signals for switching ON and OFF, control signals for driving control of the electric motor of the passive driving wheel 102, information concerning reference input for position and speed of the passive wheel 102 and drive level change as well as a mutual function control. As explained above, the reference input for position and speed for the passive wheel 102 is calculated on the basis of the distance covered by the active driving wheel 101 and further parameters, particularly potential signals of a steering unit.

The common and simultaneous switching ON and OFF as well as the common and simultaneous change of a drive level is effected from the active side of the user, i.e. from the active driving wheel 101.

For providing the required data security all data are transmitted in fixed predetermined package sizes having unambiguous and unique addresses and check sums. All data relate to a specific operation period, for instance an operation period of 10 ms. After expiry of this period new data are transmitted. Thus, any possible fault only can have an effect during an operation period of 10 ms. Adjustments regarding the motor are stored in each motor independent of the voltage.

All transmitted data are checked whether they represent a value which makes sense from a physical point of view. Obviously faulty data are ignored. If in the course of single transmissions or commands, particularly upon switching ON, obviously inadmissible data are transmitted, the repetition of the transmission is arranged for.

In specific intervals which for instance can be 1/10 s or 1/100 s the following data are transmitted for each driving motor:

Motor number, state of operation (ready, active, stop, fault), operation voltage, temperature, current, capacity of the accumulator, speed, position, caution, fault, dislocation of the sensor, position of ON/OFF switch (operated, not operated), drive level switch (operated, not operated), quality of receipt.

Upon switching ON the following data are transmitted from each motor:

Motor number, hardware version, software version, driving mode, driving control, wheel dimension, performance (for instance drive level 1 to 3), afterrunning condition, i.e. driving characteristics after the application of manual force is terminated (for instance level 1 to 3), automatic switch OFF, sounds, operation time, switch ON counter, manufacture date, last amendment, condition of the accumulator, slave number.

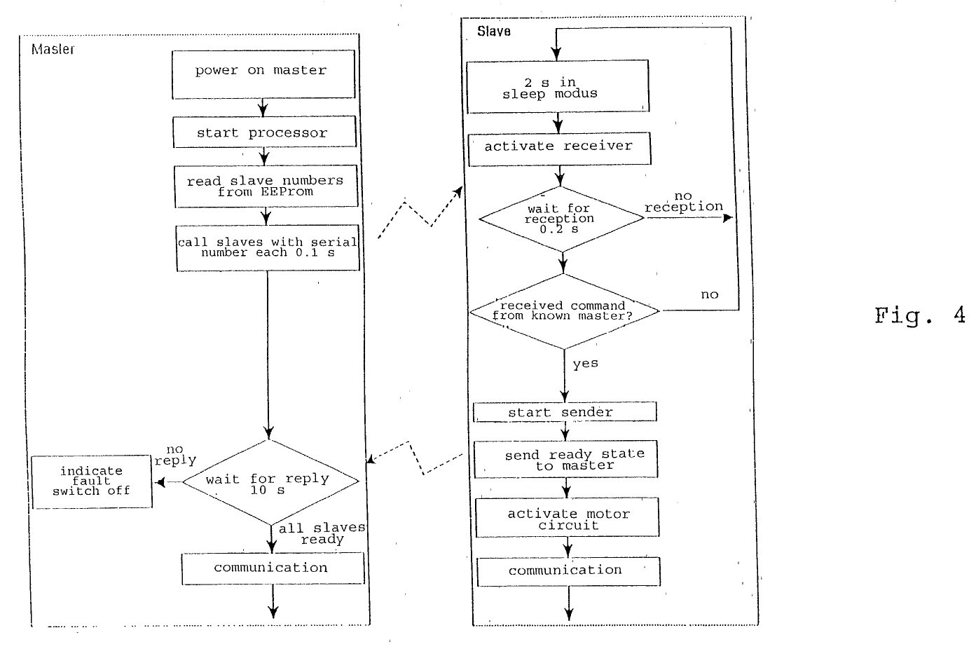

The communication flow is explained in the following with three specific sequences in connection with FIGS. 4 to 6.

FIG. 4 shows a flow chart of a start routine between master and one or several slaves. This start routine is run upon switching ON and serves to activate and synchronize the “sleeping” slaves being in a stand-by modus by the master. As already explained, the master is always that component of the network by which the switch ON operation is effected, i.e. that network component which has the ON/OFF switch for switching ON the device which is operated.

In the start routine all slaves are woken up and switched on by the master. The presence of all components is checked and subsequently data communication is started in a synchronized manner. If a fault is detected, no activation of the whole system will be effected.

As can be seen in FIG. 4, at first the processor of the master is started upon switching ON and the slave numbers are read from an EE-PROM. Subsequently the slaves are called with their serial numbers wherein one call is effected every 0.1 sec. The slaves are in a sleep modus for a time period of 2 sec. Subsequently, the receiver of the slaves is activated and waits for receipt of a command for 0.2 sec. If no command is received or only a command is received which does not come from a known master the slave turns back to the sleep modus for another 2 sec. If a command from a known master is received, the sender is started, a ready signal is sent to the master, if applicable, a motor circuit is activated if the slave is a data transmission unit of a driving wheel and communication is started.

If the master does not receive ready signals of all slaves after expiry of 10 sec, indication of a fault is given and slaves which already have been activated are switched OFF. If the master has received ready signals from all called slaves prior to expiry of 10 s the communication is started.

During operation the slaves are contacted by the master in specific time intervals. The time intervals can be for instance 10 ms or 100 ms.

Within the respective time intervals the slaves must answer. Upon sending and receiving each data package is provided with the complete address including the serial number for control and verification. Additionally, the frequency is changed to a new frequency after each data transmission. As to this, master and slave use a predetermined rhythm for changing channels which is dependent on the serial number.

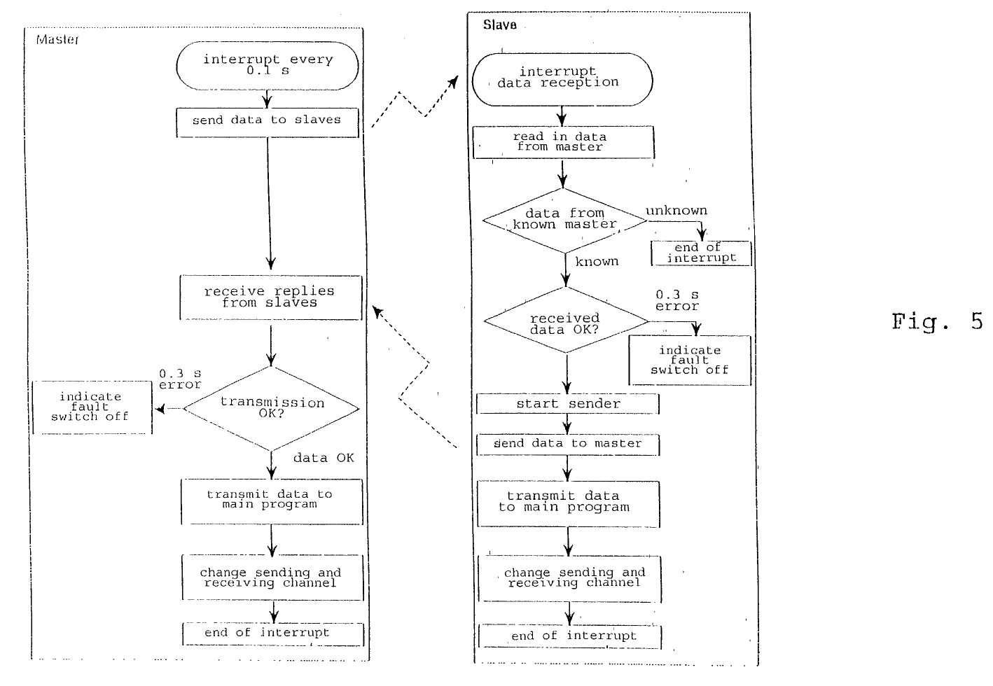

As shown in FIG. 5, the master sends an interrupt each 0.1 sec. Within this gap of time all data are sent to the slaves. The data of the master are read in by the slaves upon receipt thereof and it is checked whether the master is known. If the master is unknown, the interrupt is terminated. If the master is known, the received data are checked. If faulty data are determined three times in a row, a fault is indicated and the device is switched OFF. If the interrupt is 0.1 sec, it is ensured that switching OFF is effected 0.3 sec after occurrence of a fault. If the checking frequency is increased by one or several orders of magnitude, the reaction time can be shortened correspondingly.

If the date are without any faults, the sender of the slave is started, data of the slaves are sent to the master, corresponding data are transferred to the main program, the sending and receiving channels are changed and the interrupt is terminated.

After the master has received the data from the slave, the transmitted data are checked. If faulty data are transmitted three times in a row, the device is switched OFF and a fault is indicated. If the data are without any faults, they are transmitted to the main program, the sending and receiving channels are changed and the interrupt is terminated.

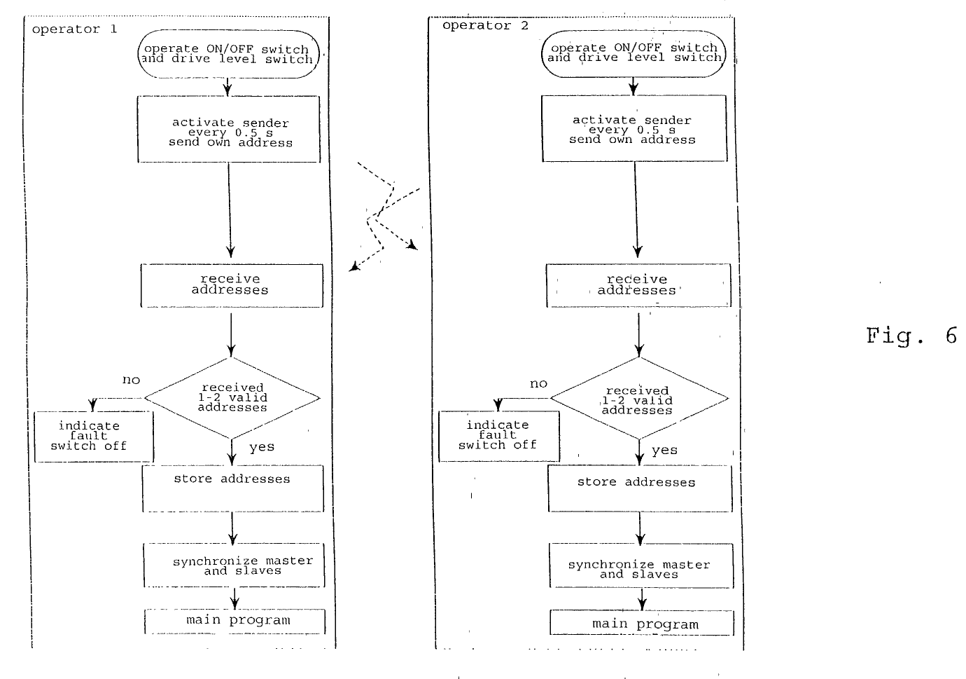

Making reference to FIG. 6 the communication sequence in the learning phase of the system is explained in the following. The system includes an operation unit having a central data transmission unit and two driving motors. Each component of this system or network, respectively, has its own unambiguous and unequivocal code number. This code number consists of a manufacturer number, a number indicating the kind of device (operation unit or motor) and a serial number and is worldwide unique for each device. In addition to its own code number each component of the system must know the code number of the other network components so that these can be contacted. These numbers can be programmed in the production facilities. Furthermore, it is possible that a learning phase is initiated if single components are exchanged so that a new component is recognized in the system and can be integrated therein.

It is for instance possible to simultaneously operate the drive level switch and the ON/OFF switch in order to activate the operation mode of the learning phase which serves to provide that the single components know each other. Appropriate permanent beep tones or indications via a liquid crystal display can signalize the user that the learning phase is active. The learning phase remains active for a maximum of 30 sec. Subsequently all components are switched OFF again.

During the learning phase each device sends its own code number and receives corresponding code numbers of the other devices. If each component receives only two code numbers and the manufacturer number as well as the number indicating the kind of device are correct, these numbers are stored in the corresponding component. If during the learning phase of a system within the radio range the learning phase of a further system is active at the same time, each component would recognize more than two further components. This is detected as a fault. The learning phase is then terminated and a fault is indicated. In such cases the learning phase has to be activated again.

In order to successfully terminate a learning phase it is thus necessary that within the radio range the learning phase of another corresponding system does not take place at the same time. This is no limitation under practical aspects. As explained above, during normal operation the simultaneous operation of a corresponding further system does not cause any problems since, as explained above, each data package is provided with a complete address so that only those data of the components of a system are used which originate from components in the same system. Simultaneous operation of two or more wheel chairs within radio range is thus possible without any problems.

Successful termination of the learning phase can be indicated by signal tones or via an appropriate optical display. If a learning phase could not be terminated successful, all data as hitherto stored are maintained. This ensures that if the learning phase for only one component of the system is inadvertently activated the whole system can be further used after termination of the learning phase.

For initiating the learning phase the ON/OFF switch and the drive level switch is simultaneously operated at all components which are to be integrated in a system. This activates the learning phase for the respective component. If the learning phase is active for 30 s as in case of the embodiment as just described, this means that within 30 s all devices have to be activated by simultaneously operating the ON/OFF switch and the drive level switch. This kind of actuation ensures that only those components are activated for conducting the learning phase which belong to a common system. In particular, it is avoided that components of other systems which are located within the radio range are inadvertently activated for conducting the learning phase. This could be particularly the case upon activation of the learning phase in the production facilities where usually a plurality of components are present.

After activation of the learning phase the sender of each component is activated and sends its own address each 0.5 sec. If in case of a system comprising only two components, i.e. a wheel chair having two driving wheels and no operation unit, a valid address is recognized or, in case of a system having three components, i.e. a wheel chair having two driving wheels and a central operation unit, two valid addresses are received, these addresses are stored, master and slaves are synchronized and the main routine is started. Otherwise, a fault is indicated and the system is switched OFF.

The embodiments as described above have several safety features for the sake of protection in case of the occurrence of faults. If for instance the master or one of the slaves should detect a fault which is critical as far as safety is concerned, the corresponding system component sends an information to all other system components and members of the network. This leads to immediate switching OFF of all motors. The master repeats sending of the error signals subsequently in the usual rhythm of transmission for a predetermined period, for instance 5 s in order to ensure that even in case of temporary faulty radio connection switching OFF will be effected promptly. A corresponding routine is run in case that a control signal of one component of the system is missing once or several times or during a predetermined interval of time.

As already explained, error detection is conducted during communication. Specifically, the size of the data package is monitored and a check sum is checked whether it is correct. If within a predetermined period of time, for instance within 0.3 sec, no data package without any errors or faults is transmitted, an error signal is sent to all network components and switching OFF is effected.

The same happens in case of interrupted radio connection. If for instance one of the slaves should not respond to the master after having been required to do so for three times in a row, an error signal is sent to all components and the system is switched OFF. The system is also switched OFF and a fault signal is given in case a slave should not receive any command from the master within 0.3 sec. This ensures that in case of a faulty radio connection the master as well as the slaves are deactivated. Deactivation should be effected in case of a fault as simultaneous as possible and within a short period of time, preferably within 0.1 sec.

Although the invention has been described with reference to exemplary embodiments, it is not limited thereto. Rather, the appended claims should be construed to include other variants and embodiments of the invention which may be made by those skilled in the art without departing from the true spirit and scope of the presentinvention.

What is claimed:

1. A vehicle, comprising a vehicle frame, an electronic control unit and at least two driving wheels;
wherein at least a first driving wheel of said two driving wheels includes a device for manually applying a driving force, and at least a second driving wheel of said two driving wheels is adapted to be driven by a drive unit having an electric motor; and
wherein a distance covered by said manually driven first driving wheel can be determined by said electronic control unit, and said electric motor of said second driving wheel is adapted to rotate said second driving wheel depending on the distance covered by said first driving wheel.

2. The vehicle as claimed in claim 1, wherein said electronic control unit is adapted to drive said driving unit having an electric motor of said second driving wheel such that said second driving wheel covers the same distance as said first driving wheel in order to provide that the vehicle is driving straight ahead.

3. The vehicle as claimed in claim 1, wherein said electronic control unit is adapted to drive said driving unit having an electric motor of said second driving wheel such that in order to provide that the vehicle takes a predetermined corner said second driving wheel covers a distance which has a predetermined ratio to the distance covered by said first driving wheel.

4. The vehicle as claimed in claim 1, wherein a steering unit is provided and said electronic control unit is adapted to drive said driving unit having an electric motor of that second driving wheel such that said second driving wheel covers the same distance as the first driving wheel in order to provide that the vehicle goes straight ahead if the steering unit is not operated and that the driving unit having an electric motor of said second driving wheel is driven in dependence of operation of said steering unit such that said second driving wheel covers a distance which is different from the distance covered by said first driving wheel.

5. The vehicle as claimed in claim 1, wherein said electronic control unit is adapted to drive said driving unit having an electric motor of said second driving wheel such that said second driving wheel covers a distance equal to the distance covered by said first driving wheel in a direction opposite to said first driving wheel, so that the vehicle turns at its present position.

6. A wheelchair, comprising a vehicle frame, an electronic control unit and at least two driving wheels;
wherein at least a first driving wheel includes a device for manually applying a driving force and at least a second driving wheel is adapted to be driven by a drive unit having an electric motor; and
wherein a distance covered by said manually driven first driving wheel can be determined by said electronic control unit and said electric motor of said second driving wheel is adapted to rotate said second driving wheel depending on the distance covered by said first driving wheel.

7. The wheelchair as claimed in claim 6, wherein said electronic control unit is adapted to drive said driving unit having an electric motor of said second driving wheel such that said second driving wheel covers the same distance as said first driving wheel in order to provide that the wheelchair is driving straight ahead.

8. The wheelchair as claimed in claim 6, wherein said electronic control unit is adapted to drive said driving unit having an electric motor of said second driving wheel such that in order to provide that the wheelchair takes a predetermined corner said second driving wheel covers a distance which has a predetermined ratio to the distance covered by said first driving wheel.

9. The wheelchair as claimed in claim 6, wherein a steering unit is provided and that said electronic control unit is adapted to drive said driving unit having an electric motor of said second driving wheel such that said second driving wheel covers the same distance as the first driving wheel in order to provide that the wheelchair goes straight ahead if the steering unit is not operated and that the driving unit having an electric motor of said second driving wheel is driven in dependence of operation of said steering unit such that said second driving wheel covers a distance which is different from the distance covered by said first driving wheel.

10. The wheelchair as claimed in claim 6, wherein said electronic control unit is adapted to drive said driving unit having an electric motor of said second driving wheel such that said second driving wheel covers a distance which is equal to the distance covered by said first driving wheel in a direction opposite to said first driving wheel so that the wheelchair turns at its present position.

11. A wheelchair, comprising a vehicle frame, an electronic control unit and two driving wheels, each comprising a drive unit having an electric motor;
wherein a first driving wheel includes a device for manually applying a driving force and a sensor for determining said manually applied driving force, wherein said electronic control unit is adapted to drive said electric motor of said first driving wheel in response to said manually applied driving force to provide a torque for supporting said manually applied driving force; and
wherein a distance covered by said manually driven first driving wheel can be determined by said electronic control unit and said electric motor of said second driving wheel is adapted to rotate said second driving wheel depending on the distance covered by said first driving wheel.

12. The wheelchair as claimed in claim 11, wherein said electronic control unit is adapted to drive said driving unit having an electric motor of said second driving wheel such that said second driving wheel covers the same distance as said first driving wheel in order to provide that the wheelchair is driving straight ahead.

13. The wheelchair as claimed in claim 11, wherein said electronic control unit is adapted to drive said driving unit having an electric motor of said second driving wheel such that in order to provide that the wheelchair takes a predetermined corner said second driving wheel covers a distance which has a predetermined ratio to the distance covered by said first driving wheel.

14. The wheelchair as claimed in claim 11, wherein a steering unit is provided and said electronic control unit is adapted to drive said driving unit having an electric motor of that second driving wheel such that said second driving wheel covers the same distance as the first driving wheel in order to provide that the wheelchair goes straight ahead if the steering unit is not operated and that the driving unit having an electric motor of said second driving wheel is driven in dependence of operation of said steering unit such that said second driving wheel covers a distance which is different from the distance covered by said first driving wheel.

15. The wheelchair as claimed in claim 11, wherein said electronic control unit is adapted to drive said driving unit having an electric motor of said second driving wheel such that said second driving wheel covers a distance which is equal to the distance covered by said first driving wheel in a direction opposite to said first driving wheel so that the wheelchair turns at its present position.

16. The wheelchair as claimed in claim 11, wherein each driving wheel has a driving wheel sending unit for non-contact transmission of signals and a driving wheel receiving unit for non-contact receipt of external signals.

17. The wheelchair as claimed in claim 16, wherein a vehicle frame sending unit for non-contact transmission of signals to said driving wheel receiving unit and a vehicle frame receiving unit for non-contact receipt of signals is provided at the vehicle frame.

18. The wheelchair as claimed in claim 17, wherein said vehicle frame sending unit is adapted to transmit switch ON/OFF signals to said driving wheel receiving units of both driving wheels and/or a drive level selection signal to the driving wheel receiving unit of said first driving wheel.

19. The wheelchair as claimed in claim 18, wherein said vehicle frame sending unit is arranged in an operation unit or is connected with an operation unit for the purpose of exchanging signals.

20. The wheelchair as claimed in claim 19, wherein the operation unit is designed as a detachable component so that operation of the wheelchair is not possible without said operation unit.

21. The wheelchair as claimed in claim 19, wherein said operation unit is designed as a detachable component so that remote control of said wheelchair can be effected by means of said operation unit.

22. The wheelchair as claimed in claim 11, wherein said control unit is adapted to detect that the driving unit having an electric motor of one wheel is out of order and to switch OFF the other driving wheel in response thereto.

23. The wheelchair as claimed in claim 22, wherein a separate accumulator assembly is provided for each driving wheel, wherein said control unit is adapted to switch OFF both driving wheels if a signal is transmitted by the driving wheel sending unit of one wheel which signal contains information that the charging condition of the accumulator assembly of this driving wheel has reached a predetermined lower threshold value.

24. The wheelchair as claimed in claim 17, wherein said vehicle frame receiving unit is connected with a display and said display is adapted to provide an indication concerning an operational state of the wheelchair or individual components thereof, a capacity of an accumulator or the accumulators, a selected drive level, potential interruptions, faults and other operational data, particularly time, speed, distance and trip counter.

25. The wheelchair as claimed in claim 24, wherein the display is adapted to provide said indication via at least one of i) optical signals, ii) acoustic signals, iii) signals transmitted via vibration, and iv) signals transmitted via heating.

26. The wheelchair as claimed in claim 16, wherein a plurality of different frequencies are provided for non-contact receipt of external signals wherein such frequencies change in a predetermined order.

27. The wheelchair as claimed in claim 16, wherein a data package having a predetermined size and unambiguous and unique address and including external signals is provided for transmission of external signals.

28. The wheelchair as claimed in claim 27, wherein a checksum is assigned to each data package.

29. The wheelchair as claimed in claim 16, wherein said control unit is adapted to recognize an external signal as a faulty signal if it does not represent a value which makes sense from a physical point of view.

30. The wheelchair as claimed in claim 11, wherein settings of the driving unit having an electric motor can be stored independent of the voltage.

31. The wheelchair as claimed in claim 16, wherein each driving wheel and/or central operation unit is adapted to serve as a master network component and remaining network components then serve as slaves, wherein the master network component is that component which is switched ON first.

32. The wheelchair as claimed in claim 31, wherein upon each switch ON process a start routine is conducted which serves to activate the slaves by the master from a sleep modus and to synchronize the network components.

33. The wheelchair as claimed in claim 31, wherein a learning phase can be activated which serves to provide that the single network components know each other.

34. A wheelchair, comprising a vehicle frame and two driving wheels, each driving wheel comprising a drive unit having an electric motor and an electronic control unit;
wherein a first driving wheel includes a device for manually applying a driving force and a sensor for determining said manually applied driving force, wherein said electronic control unit of said first driving wheel is adapted to drive said electric motor of said first driving wheel in response to said manually applied driving force to provide a torque for supporting said manually applied driving force; and
wherein a distance covered by said manually driven first driving wheel can be determined by an electronic control unit and said electric motor of said second driving wheel is adapted to rotate said second driving wheel depending on the distance covered by said first driving wheel.

35. The wheelchair as claimed in claim 34, wherein said electronic control unit is adapted to drive said driving unit having an electric motor of said second driving wheel such that said second driving wheel covers the same distance as said first driving wheel in order to provide that the wheelchair is driving straight ahead.

36. The wheelchair as claimed in claim 34, wherein said electronic control unit is adapted to drive said driving unit having an electric motor of that second driving wheel such that in order to provide that the wheelchair takes a predetermined corner said second driving wheel covers a distance which has a predetermined ratio to the distance covered by said first driving wheel.

37. The wheelchair as claimed in claim 34, wherein a steering unit is provided and said electronic control unit is adapted to drive said driving unit having an electric motor of that second driving wheel such that said second driving wheel covers the same distance as the first driving wheel in order to provide that the wheelchair goes straight ahead if the steering unit is not operated and that the driving unit having an electric motor of said second driving wheel is driven in dependence of operation of said steering unit such that said second driving wheel covers a distance which is different from the distance covered by said first driving wheel.

38. The wheelchair as claimed in claim 34, wherein said electronic control unit is adapted to drive said driving unit having an electric motor of said second driving wheel such that said second driving wheel covers a distance which is equal as the distance covered by said first driving wheel in a direction opposite to said first driving wheel so that the wheelchair turns at its present position.

39. The wheelchair as claimed in claim 34, wherein each driving wheel has a driving wheel sending unit for non-contact transmission of signals and a driving wheel receiving unit for non-contact receipt of external signals.

40. The wheelchair as claimed in claim 39, wherein a vehicle frame sending unit for non-contact transmission of signals to said driving wheel receiving unit and a vehicle frame receiving unit for non-contact receipt of signals is provided at the vehicle frame.

41. The wheelchair as claimed in claim 40, wherein said vehicle frame sending unit is adapted to transmit switch ON/OFF signals to said driving wheel receiving units of both driving wheels and/or a drive level selection signal to the driving wheel receiving unit of said first driving wheel.

42. The wheelchair as claimed in claim 41, wherein said vehicle frame sending unit is arranged in an operation unit or is connected with an operation unit for the purpose of exchange of signals.

43. The wheelchair as claimed in claim 42, wherein the operation unit is designed as a detachable component so that operation of the wheelchair is not possible without said operation unit.

44. The wheelchair as claimed in claim 43, wherein said operation unit is designed as a detachable component so that remote control of said wheelchair can be effected by means of said operation unit.

45. e wheelchair as claimed in claim 34, wherein said control unit is adapted to detect that the driving unit having an electric motor of one wheel is out of order and to switch OFF the other driving wheel in response thereto.

46. The wheelchair as claimed in claim 45, wherein a separate accumulator assembly is provided for each driving wheel, wherein said control unit is adapted to switch OFF both driving wheels if a signal is transmitted by the driving wheel sending unit of one wheel which signal contains information that the charging condition of the accumulator assembly of this driving wheel has reached a predetermined lower threshold value.

47. The wheelchair as claimed in claim 34, wherein said vehicle frame receiving unit is connected with a display and said display is adapted to provide an indication concerning an operational state of the wheelchair or single components thereof, the capacity of an accumulator or the accumulators, a selected drive level, potential interruptions, faults and other operational data, particularly time, speed, distance and trip counter.

48. The wheelchair as claimed in claim 47, wherein the display is adapted to provide said indication via at least one of i) optical signals, ii) acoustic signals, iii) signals transmitted via vibration, and iv) signals transmitted via heating.

49. The wheelchair as claimed in claim 39, wherein a plurality of different frequencies are provided for non-contact receipt of external signals wherein such frequencies change in a predetermined order.

50. The wheelchair as claimed in claim 39, wherein a data package having a predetermined size and unambiguous and unique address and including external signals is provided for transmission of external signals.

51. The wheelchair as claimed in claim 50, wherein a checksum is assigned to each data package.

52. The wheelchair as claimed in claim 34, wherein said control unit is adapted to recognize an external signal as a faulty signal if it does not represent a value which makes sense from a physical point of view.

53. The wheelchair as claimed in claim 34, wherein settings of the driving unit having an electric motor can be stored independent of the voltage.

54. The wheelchair as claimed in claim 39, wherein each driving wheel and/or central operation unit is adapted to serve as a master network component and remaining network components then serve as slaves, wherein the master network component is that component which is switched ON first.

55. The wheelchair as claimed in claim 54, wherein upon each switch ON process a start routine is conducted which serves to activate the slaves by the master from a sleep modus and to synchronize the network components.

56. The wheelchair as claimed in claim 54, wherein a learning phase can be activated which serves to provide that the single network components know each other.

57. The wheelchair as claimed in claim 34, wherein said control units are adapted to switch OFF and ON both driving wheels simultaneously via a switch arranged at one of said driving wheels.

58. The wheelchair as claimed in claim 40, wherein said control units are adapted to switch OFF and ON said vehicle frame sending unit and said vehicle frame receiving unit simultaneously via a switch arranged at one of said driving wheels.
